(19) United States
(12) Patent Application Publication
(10) Pub. No.: US 2007/0262225 A1
(43) Pub. Date: Nov. 15, 2007

(54) DISPLAY AND ASSEMBLY STRUCTURE THEREOF

(75) Inventors: Chun Jung Tsuo, Taoyuan (TW); Han Kuang Ho, Taipei County (TW)

Correspondence Address: QUINTERO LAW OFFICE, PC, 2210 MAIN STREET, SUITE 200, SANTA MONICA, CA, 90405, US

(73) Assignee: BENQ CORPORATION, Taoyuan (TW)

(21) Appl. No.: 11/745,382

(22) Filed: May 7, 2007

(30) Foreign Application Priority Data
May 11, 2006 (TW) TW95116688

(51) Int. Cl. F16M 3/00

(52) U.S. Cl. 248/676

(57) ABSTRACT

A display comprises a seat, a panel and an assembly structure. The assembly structure disposed between the seat and the panel comprises a first element disposed on the seat and a second element disposed between the first element and the panel. The first element has a first reference position. The second element, rotatably moved between a first status and a second status with respect to the first element, comprises a first positioning portion moved between first and second positions, a second positioning portion moved between third and fourth positions. When the first positioning portion is moved from the first position to the second position and the second positioning portion is moved from the third position to the fourth position, the second element is moved from the first status to the second status, and a difference is formed between the first and second reference heights.

### BACKGROUND OF THE INVENTION

1. Field of the Invention

The invention relates to a display, and in particular to a display capable of adjusting the height of a panel when the panel is rotated.

2. Description of the Related Art

With respect to large-size panels, a large-size panel must be lifted to a desired height before rotation to prevent contact with a seat thereof when the panel is rotated. However, rotation and height adjustment on the panel are two independent functions, i.e., rotation and height adjustment of the panel cannot be performed simultaneously, thus, operation is inconvenient and panel cost is increased.

### BRIEF SUMMARY OF THE INVENTION

The invention provides a display comprising a seat, a panel and an assembly structure disposed between the seat and the panel, so that rotation and height adjustment of the panel can be performed simultaneously. The assembly structure comprises a first element and a second element. The second element, relatively disposed and moved between a first status and a second status with respect to the first element, comprises a first positioning portion and a second positioning portion. The first positioning portion is moved between a first position and a second position, and the second positioning portion is moved between a third position and a fourth position.

When the first positioning portion is moved from the first position to the second position and the second positioning portion is moved from the third position to the fourth position, the second element is moved from the first status to the second status, thus, the panel is moved.

The display further comprises a base surface and a first reference height when the second element is in the first status, and the first reference height is a height measured from a first reference point of the first element to the base surface. The display further comprises a second reference height when the second element is in the second status, and the first reference height is a height measured from a second reference point of the second element to the base surface.

The second reference height is greater than the first reference height. The first element further comprises a first path and a second path, and the first positioning portion is moved along the first path and the second positioning portion is moved along the second path. The first positioning portion is engaged to the first path, and the second positioning portion is engaged to the second path. The first positioning portion and the second positioning portion comprise protrusions. The first path and the second path can be slots. The first path and the second path are symmetrically arranged. The second element of the assembly structure and the panel are integrally formed.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a perspective view of a display of the invention;

FIG. 2A is a perspective view of the display at a first reference height;

FIG. 2B is a perspective view of the display at a second reference height;

FIG. 3A is an enlarged view of a dotted zone Z1 of FIG. 2A;

FIG. 3B is an enlarged view of a dotted zone Z2 of FIG. 2B; and

FIG. 4 is a perspective view of the display of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

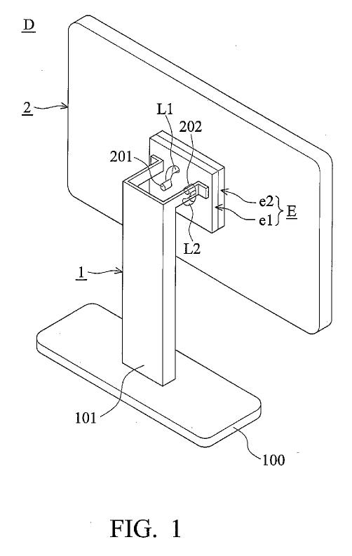

In FIG. 1, a display D of the embodiment comprises a seat 1 having a base surface 100 and a post 101, a panel 2 and an assembly structure E disposed between the seat 1 and the panel 2.

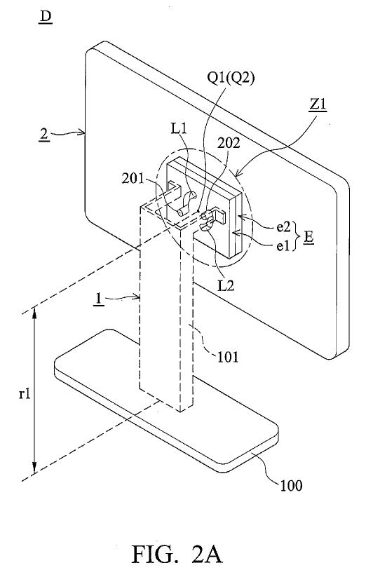

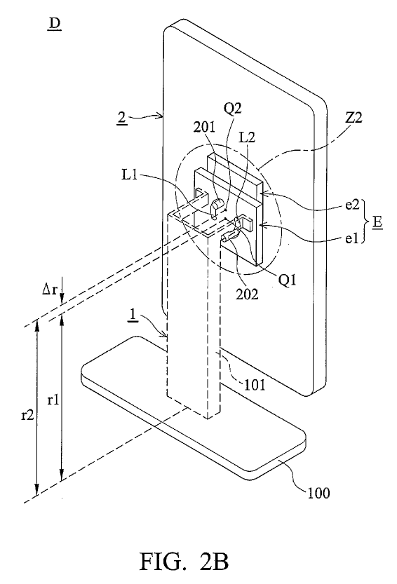

The panel 2 is capable of being rotated to different positions by the assembly structure E with respect to the base surface 100 of the seat 1. In FIGS. 2A and 2B, the panel 2 is located at a first reference height r1 and a second reference height r2, respectively.

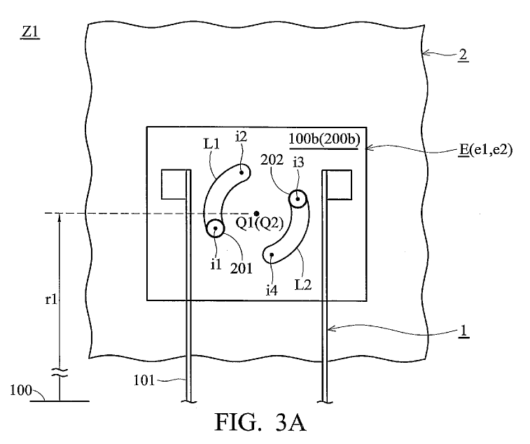

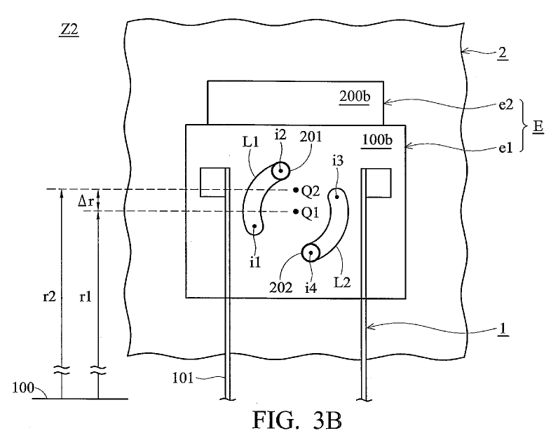

FIGS. 3A and 3B are enlarged views of dotted zones Z1 and Z2 of FIGS. 2A and 2B, respectively. The assembly structure E comprises a first element e1 disposed on the post 101 of the seat 1 and a second element e2 movably disposed between the first element e1 and the panel 2.

The first element e1 comprises a first body 100b, a first reference height r1, and a reference point Q1 located at the first body 100b. The first reference height r1 is a distance measured from the reference point Q1 and the base surface 100 of the seat 1.

The second element e2, movably disposed between a first status (FIG. 3A) and a second status (FIG. 3B) with respect to the first element e1, comprises a second body 200b, a first positioning portion 201 movable between a first position i1 and a second position i2, a second positioning portion 202 movable between a third position i3 and a fourth position i4, a second reference height r2 and a reference point Q2 located at the second body 200b. The second reference height r2 is a distance measured from the reference point Q2 and the base surface 100 of the seat 1. In FIG. 3A, the reference points Q1 and Q2 are overlapped. In this embodiment, the second element e2 and the panel 2 are integrally formed, and the first and second positioning portions 201 and 202 are two protrusions formed on the second body 200b.

When the first positioning portion 201 is moved from the first position i1 to the second position i2 and the second positioning portion 202 is moved from the third position i3 to the fourth position i4, the second element e2 is moved from the first status (FIG. 3A) to the second status (FIG. 3B), so that the panel 2 is moved and a difference Δr exists between the first and second reference heights r1 and r2.

The first element e1 comprises a first path L1 located between the first and second positions i1 and i2 and a second path L2 located between the third and fourth positions i3 and i4. The first positioning portion 201 engaged to the first path L1 is limited and the second positioning portion 202 engaged to the second path L2 is limited, so that the first positioning portion 201 is moved along the first path L1 and the second positioning portion 202 is moved along the second path L2. In this embodiment, the first and second paths L1 and L2 are two curved slots symmetrically arranged, and the distance between the first and second positioning portions 201 and 202 is constant.

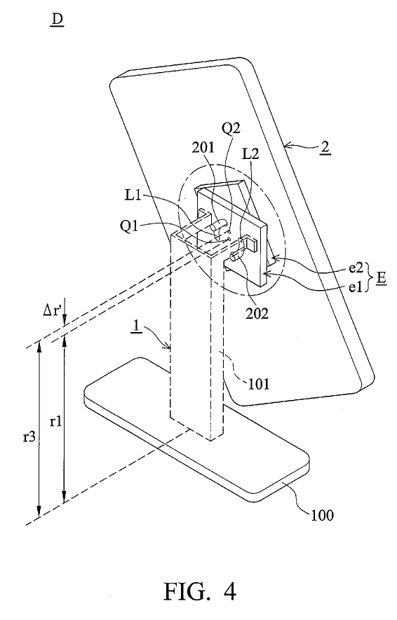

In FIG. 4, when the panel 2 is rotated with respect to the seat 1 as the first positioning portion 201 is moved from the first position i1 to the second position i2 and the second positioning portion 202 is moved from the third position i3 to the fourth position i4 with respect to the first positioning portion 201, the panel 2 is lifted by a height Δr′, i.e., the difference between first reference height r1 and a third reference height r3 to prevent the panel 2 from contacting the base surface 100 of the seat 1.

Note that the first and second paths L1 and L2 are configured under the required elevated height of the panel 2. Thus, the panel 2 is correspondingly elevated or adjusted during the rotation of the panel 2.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An assembly structure, comprising:
a first element; and
a second element relatively disposed and moved between a first status and a second status with respect to the first element, comprising a first positioning portion and a second positioning portion, wherein the first positioning portion is moved between a first position and a second position, and the second positioning portion is moved between a third position and a fourth position; when the first positioning portion is moved from the first position to the second position and the second positioning portion is moved from the third position to the fourth position, the second element is moved from the first status to the second status.

2. The assembly structure as claimed in claim 1 further comprising a base surface and a first reference height when the second element is in the first status, and the first reference height is a height measured from a first reference point of the first element to the base surface.

3. The assembly structure as claimed in claim 2 further comprising a second reference height when the second element is in the second status, and the second reference height is a height measured from a second reference point of the second element to the base surface.

4. The assembly structure as claimed in claim 3, wherein the second reference height is not equal to the first reference height.

5. The assembly structure as claimed in claim 4, wherein the second reference height is greater than the first reference height.

6. The assembly structure as claimed in claim 1, wherein the first element further comprises a first path and a second path, and the first positioning portion is moved along the first path and the second positioning portion is moved along the second path.

7. The assembly structure as claimed in claim 6, wherein the first positioning portion is engaged to the first path, and the second positioning portion is engaged to the second path.

8. The assembly structure as claimed in claim 6, wherein the first path and the second path comprise slots.

9. The assembly structure as claimed in claim 6, wherein the first path and the second path are symmetrically arranged.

10. The assembly structure as claimed in claim 1, wherein the first positioning portion and the second positioning portion comprise protrusions.

11. A display, comprising:
a seat;
a panel; and
an assembly structure disposed between the seat and the panel, the assembly structure comprising:
a first element; and
a second element relatively disposed and moved between a first status and a second status with respect to the first element, comprising a first positioning portion and a second positioning portion, wherein the first positioning portion is moved between a first position and a second position, and the second positioning portion is moved between a third position and a fourth position; when the first positioning portion is moved from the first position to the second position and the second positioning portion is moved from the third position to the fourth position, the second element is moved from the first status to the second status, so that the panel is moved.

12. The display as claimed in claim 11 further comprising a base surface and a first reference height when the second element is in the first status, and the first reference height is a height measured from a first reference point of the first element to the base surface.

13. The display as claimed in claim 12 further comprising a second reference height when the second element is in the second status, and the second reference height is a height measured from a second reference point of the second element to the base surface.

14. The display as claimed in claim 13, wherein the second reference height is greater than the first reference height.

15. The display as claimed in claim 11, wherein the first element further comprises a first path and a second path, and the first positioning portion is moved along the first path and the second positioning portion is moved along the second path.

16. The display as claimed in claim 15, wherein the first positioning portion is engaged to the first path, and the second positioning portion is engaged to the second path.

17. The display as claimed in claim 15, wherein the first path and the second path comprise slots.

18. The display as claimed in claim 15, wherein the first path and the second path are symmetrically arranged.

19. The display as claimed in claim 11, wherein the first positioning portion and the second positioning portion comprise protrusions.

20. The display as claimed in claim 11, wherein the second element of the assembly structure and the panel are integrally formed.
